(19) United States
(12) Patent Application Publication
(10) Pub. No.: US 2022/0391698 A1
(43) Pub. Date: Dec. 8, 2022

(54) Training Recognition Device

(71) Applicant: Hitachi, Ltd., Tokyo (JP)

(72) Inventors: Takashi OSHIMA, Tokyo (JP); Goichi ONO, Tokyo (JP); Akira KITAYAMA, Tokyo (JP); Ming LIU, Tokyo (JP)

(21) Appl. No.: 17/748,710

(22) Filed: May 19, 2022

(30) Foreign Application Priority Data
Jun. 8, 2021 (JP) 2021-095798

(51) Int. Cl. G06N 3/08; G06N 3/04; G06V 10/77; G06V 10/776; G06V 10/82

(52) U.S. Cl. CPC G06N 3/08; G06N 3/0454; G06V 10/7715; G06V 10/776; G06V 10/82

(57) ABSTRACT

Provided is a training recognition device that implements training of a DNN for article recognition that does not require manual annotation for an image for training and can reduce power consumption, time, and hardware amount required for training. The training recognition device includes: an image conversion unit that inputs a simulation image and an actual site image into a generative adversarial network and converts the simulation image into an artificial site image; a pre-trained feature extraction unit that inputs the simulation image to a trained deep neural network trained using the simulation image and annotation data for the simulation image and outputs a feature point of the simulation image at time of re-training; a re-training feature extraction unit that inputs the artificial site image to a deep neural network for re-training, re-trains a difference between the simulation image and the artificial site image, and outputs a feature point of the artificial site image; an error calculation unit for feature extraction unit that calculates a difference between the feature point output by the re-training feature extraction unit and the feature point output by the pre-trained feature extraction unit; a coefficient update unit for feature extraction unit that updates a coefficient of the re-training feature extraction unit used for re-training based on the difference; and a re-training identification unit that re-trains a method for identifying an article based on a feature point output from the deep neural network for re-training of the coefficient updated by the coefficient update unit for feature extraction unit.

### BACKGROUND OF THE INVENTION

### 1. Field of the Invention

The present invention relates to deep learning.

### 2. Description of the Related Art

A need for recognizing articles to which artificial intelligence (AI) is applied is increasing in logistics and production fields against a background of a forecast of a decrease in working population. For example, it is necessary to take a picture of an article flowing on a belt conveyor with a camera and recognize a type, a position, normality/abnormality, and the like of the article by AI from the obtained image.

In recent years, deep learning is developed as AI for image recognition. The deep learning can classify articles and detect position information by calculation using a deep neural network (DNN).

The deep neural network has a problem of efforts required for training. One example of the efforts is to manually label (annotate) correct answer information for plural images for training. Therefore, in recent years, a method is developed in which an image for training and the correct answer information are generated as a pair by simulation, and DNN is trained using the image for training and the correct answer. However, due to a difference between a simulation image and a real image, a recognition accuracy may deteriorate when the DNN trained with the simulation image is used for the real image.

JP-A-2020-119553 tries to solve the above problem by converting a real image into an image imitating a simulation image by a cycle generative adversarial network (GAN).

JP-A-2020-119554 tries to solve the above problem by generating an image imitating a real image from a simulation image with a cycle GAN and using the generated image for training.

Another problem of the deep learning is how to reduce power consumption, time, and hardware amount required for training, since training using backpropagation that is applied in the related art goes back from the back of the DNN to train the entire DNN and a necessary calculation amount increases. In this manner, in the related art, a problem is to reduce the efforts of manually annotating an image for training and to reduce the power consumption, time, and hardware amount required for training.

### SUMMARY OF THE INVENTION

One aspect of the invention is to implement training of a DNN for article recognition that does not require manual annotation for an image for training and can reduce power consumption, time, and hardware amount required for the training.

A training recognition device according to one aspect of the invention includes: an image conversion unit that inputs a simulation image and an actual site image into a generative adversarial network and converts the simulation image into an artificial site image; a pre-trained feature extraction unit that inputs the simulation image to a trained deep neural network trained using the simulation image and annotation data for the simulation image and outputs a feature point of the simulation image at time of re-training; a re-training feature extraction unit that inputs the artificial site image to a deep neural network for re-training, re-trains a difference between the simulation image and the artificial site image, and outputs a feature point of the artificial site image; an error calculation unit for feature extraction unit that calculates a difference between the feature point output by the re-training feature extraction unit and the feature point output by the pre-trained feature extraction unit; a coefficient update unit for feature extraction unit that updates a coefficient of the re-training feature extraction unit used for re-training based on the difference; and a re-training identification unit that re-trains a method for identifying an article based on a feature point output from the deep neural network for re-training of the coefficient updated by the coefficient update unit for feature extraction unit.

According to an aspect of the invention, manual annotation for an image for training is not necessary, and power consumption, time, and hardware amount required for training can be reduced.

### BRIEF DESCRIPTION OF THE DRAWINGS

FIG. 1 is a diagram showing a first embodiment of the invention;

FIG. 2 is a diagram showing a time chart of the first embodiment of the invention;

FIG. 3 is a diagram showing a second embodiment of the invention;

FIG. 4 is a diagram showing a third embodiment of the invention;

FIG. 5 is a diagram showing a time chart of the third embodiment of the invention;

FIG. 6 is a diagram showing a fourth embodiment of the invention;

FIG. 7 is a diagram showing a fifth embodiment of the invention;

FIG. 8 is a diagram showing a sixth embodiment of the invention;

FIG. 9 is a diagram showing a seventh embodiment of the invention; and

FIG. 10 is a diagram showing a schematic configuration example of a computer.

### DESCRIPTION OF THE PREFERRED EMBODIMENTS

Hereinafter, embodiments of the invention will be described with reference to the drawings. The following description and drawings are examples for describing the invention, and are omitted and simplified appropriately for clarification of the description. The invention can be implemented in various other forms. Unless otherwise limited, each component may be singular or plural.

Positions, sizes, shapes, ranges, and the like of the components showed in the drawings may not represent actual positions, sizes, shapes, ranges, and the like in order to facilitate understanding of the invention. Therefore, the invention is not necessarily limited to the positions, sizes, shapes, ranges, and the like disclosed in the drawings.

In the following description, although various types of information may be described in terms of expressions such as “database”, “table” and “list”, the various types of information may be expressed by other data structures. “XX table”, “XX list”, and the like may be referred to as “XX information” to indicate that the information does not depend on a data structure. In describing identification information, when expressions such as “identification information”, “identifier”, “name”, “ID”, and “number” are used, these expressions may be replaced with each other.

When there are a plurality of components having the same or similar function, different subscripts may be attached to the same reference sign. However, when there is no need to distinguish the plurality of components, the subscripts may be omitted.

In the following description, processing performed by executing a program may be described. The program is executed by a processor (for example, a central processing unit (CPU) or a graphics processing unit (GPU)) to perform predetermined processing using a storage resource (for example, a memory) and/or an interface device (for example, a communication port), or the like appropriately. Therefore, the processor may serve as a subject of the processing. Similarly, a subject of the processing performed by executing a program may be a controller, a device, a system, a computer, or a node that includes a processor. The subject of the processing performed by executing the program may be a calculation unit, and may include a dedicated circuit (for example, a field-programmable gate array (FPGA) or an application specific integrated circuit (ASIC)) that performs specific processing.

The program may be installed from a program source into a device such as a computer. The program source may be, for example, a program distribution server or a computer-readable storage medium. When the program source is the program distribution server, the program distribution server may include a processor and a storage resource that stores a program to be distributed, and the processor of the program distribution server may distribute the program to be distributed to another computer. In the following description, two or more programs may be implemented as one program, or one program may be implemented as two or more programs.

Functions and processing in the following embodiments can be implemented by a general computer 1600 as shown in FIG. 10 (a schematic diagram of a computer) that includes a CPU 1601, a memory 1602, an external storage device 1603 such as a hard disk drive (HDD), a read and write device 1607 that reads and writes information from and into a portable storage medium 1608 such as a compact disk (CD) or a USB memory, an input device 1606 such as a keyboard or a mouse, an output device 1605 such as a display, a communication device 1604 such as a network interface card (NIC) for connecting to a communication network, and internal communication lines 1609 (referred to as system buses) such as system buses that connect these devices.

Various data stored in the present device or system or used for processing can be implemented by being read and used by the CPU 1601 from the memory 1602 or the external storage device 1603. Each functional unit (for example, in the first embodiment, an image conversion unit 11, a re-training feature extraction unit 12, a fixed feature extraction unit 13, a re-training identification unit 14, a pre-trained feature extraction unit 15, an error calculation unit for feature extraction unit 16, a coefficient update unit for feature extraction unit 17, an error calculation unit for identification unit 18, and a coefficient update unit for identification unit 19) included in the present device or system can be implemented by loading a predetermined program stored in the external storage device 1603 into the memory 1602 and executing the program by the CPU 1601.

The predetermined program described above may be stored (downloaded) in the external storage device 1603 from the storage medium 1608 via the read and write device 1607 or from a network via the communication device 1604, and may then be loaded into the memory 1602 and be executed by the CPU 1601. The program may also be loaded directly into the memory 1602 from the storage medium 1608 via the read and write device 1607 or from the network via the communication device 1604 and then executed by the CPU 1601.

In the following description, an example will be given in which the present device or system includes one computer. Alternatively, all or a part of these functions may be distributed to one or more computers such as a cloud, and the same functions may be implemented by communication with each other via a network. FIG. 10 shows the computer 1600 including the CPU 1601, and the functions and processing in the following embodiments may be implemented by using a GPU 1610 and an accelerator (dedicated circuit) 1611.

### First Embodiment

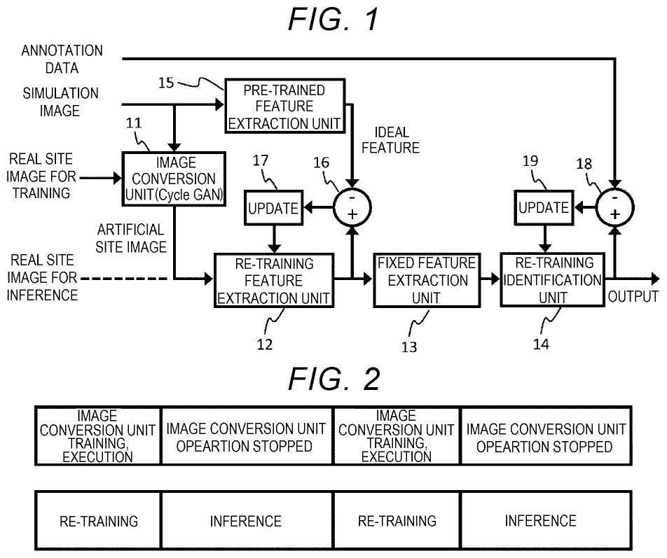

A configuration according to the first embodiment of the invention is shown in FIG. 1, and a time chart thereof is shown in FIG. 2. With the configuration of FIG. 1, as shown in FIG. 2, re-training of a deep neural network (DNN) for article recognition and inference by the re-trained DNN for article recognition are performed.

An image for re-training (simulation image) generated by simulation and correct answer information (annotation data) accompanying the image are supplied at the time of re-training. The simulation image is generated by simulating a shape, a pattern, a color, and the like of an article to be recognized. The annotation data is obtained by converting an item of and position information on the article shown in each simulation image into data. The position information is a coordinate, a width, and a height of a bounding box surrounding the article, a group of coordinates representing a contour of the article, and the like.

At the time of the re-training, the simulation images are input to the image conversion unit 11, and the image conversion unit 11 converts each simulation image into an image (artificial site image) imitating a site image including the article to be recognized. The image conversion unit 11 performs the above conversion according to the configuration of the cycle generative adversarial network (GAN) shown in JP-A-2020-119553. In order to train the conversion from the simulation image to the image imitating the site image, the image conversion unit 11 is also supplied with an actual site image (real site image for training) including the article to be recognized. As shown in FIG. 2, the image conversion unit 11 executes the conversion while training the conversion. Accordingly, a site image associated with the annotation data can be obtained as the output of the image conversion unit 11, although the site data is an artificial image (artificial site image).

At the time of re-training, the artificial site image is input to the DNN for article recognition. The DNN for article recognition includes the re-training feature extraction unit 12, the fixed feature extraction unit 13, and the re-training identification unit 14 in this order. At the time of re-training, the simulation image is also input to the pre-trained feature extraction unit 15. In the same manner as described above, the DNN is trained in advance using the image generated by the simulation and the correct answer information, and a portion of the feature extraction unit in a preceding stage of a pre-trained DNN model is applied to the pre-trained feature extraction unit 15. The re-training feature extraction unit 12 also includes the same network structure as that of the pre-trained feature extraction unit 15.

The pre-trained feature extraction unit 15 outputs a feature point corresponding to each supplied simulation image. The re-training of the re-training feature extraction unit 12 is performed using a group of the feature point (ideal features). That is, a difference between a feature point output from the re-training feature extraction unit 12 and a feature point (ideal feature) output from the pre-trained feature extraction unit 15 is calculated by the error calculation unit for feature extraction unit 16. Further, the coefficient update unit for feature extraction unit 17 updates a coefficient for the re-training feature extraction unit 12 based on the difference, and supplies the updated coefficient to the re-training feature extraction unit 12. The coefficient is a weight coefficient, a bias coefficient, or the like of each neuron in the re-training feature extraction unit 12. Before the re-training, the coefficient update unit for feature extraction unit 17 sets an initial coefficient to the same coefficient as that of the pre-trained feature extraction unit 15. Accordingly, the coefficient of the re-training feature extraction unit 12 is updated such that the feature point output from the re-training feature extraction unit 12 is as close as possible to the feature point output from the pre-trained feature extraction unit 15. Accordingly, a difference between the artificial site image and the simulation image is absorbed in the re-training feature extraction unit 12. That is, a feature point similar to the feature point of the simulation image is obtained as the output of the re-training feature extraction unit 12.

As the subsequent fixed feature extraction unit 13, a portion of the feature extraction unit subsequent to the feature extraction unit of the preceding stage of the pre-trained DNN model is applied. The portion corresponds to the simulation image, and thus the output of the re-training feature extraction unit 12 can be processed as it is. Therefore, the coefficient of the fixed feature extraction unit 13 is fixed as it is without re-training.

The re-training feature extraction unit 12 trains differences such as a light amount, a contrast, a texture, resolution, and noise of the simulation image from the site image, whereas the re-training identification unit 14 trains a method for identifying a type and a position of an article from the feature point output by the fixed feature extraction unit 13. Therefore, the difference between the output of the re-training identification unit 14 and the annotation data is calculated by the error calculation unit for identification unit 18. The coefficient update unit for identification unit 19 updates a coefficient for the re-training identification unit 14 based on the difference, and supplies the updated coefficient to the re-training identification unit 14. The coefficient is a weight coefficient, a bias coefficient, or the like of each neuron in the re-training identification unit 14. Accordingly, the coefficient of the re-training identification unit 14 is updated such that the output of the re-training identification unit 14 is as close as possible to the annotation data.

As shown in FIG. 2, after the completion of re-training, the inference, that is, the recognition is executed. At this time, coefficients of the re-training feature extraction unit 12 and the re-training identification unit 14 are fixed to coefficients obtained at the time of re-training. At the time of inference, an operation of the image conversion unit 11 is not necessary. Therefore, for example, as shown in FIG. 2, an operation of the image conversion unit 11 is stopped to reduce power consumption.

As shown in FIG. 2, a re-training period and an inference period may be alternately provided, and the re-training may be repeated periodically or irregularly. Accordingly, it is possible to follow the change of the site image caused by the change of illumination, external light, vibration, an angle of view of the camera, characteristics of the camera, and the like, and to adapt to the change and addition of the item and the change in a recognition content such as classification, bounding box detection, and contour detection at any time.

In this manner, in the present embodiment, the training recognition device includes: the image conversion unit (for example, the image conversion unit 11) that inputs the simulation image and the actual site image into the generative adversarial network and converts the simulation image into the artificial site image; the pre-trained feature extraction unit 15 that inputs the simulation image to a trained deep neural network (for example, the pre-trained DNN model) trained using the simulation image and annotation data for the simulation image and outputs a feature point of the simulation image at the time of re-training; the re-training feature extraction unit 12 that inputs the artificial site image to the deep neural network for re-training (for example, a DNN model having the same network structure as the pre-trained feature extraction unit 15), re-trains a difference between the simulation image and the artificial site image, and outputs a feature point of the artificial site image; the error calculation unit for feature extraction unit 16 that calculates a difference between the feature point output by the re-training feature extraction unit and the feature point output by the pre-trained feature extraction unit; the coefficient update unit for feature extraction unit 17 that updates the coefficient of the re-training feature extraction unit used for re-training based on the difference; and the re-training identification unit 14 that re-trains a method for identifying an article based on a feature point output from the deep neural network for re-training of the coefficient updated by the coefficient update unit for feature extraction unit.

The training recognition device further includes: the error calculation unit for identification unit 18 that calculates a difference between output data of the re-training identification unit and the annotation data; and the coefficient update unit for identification unit 19 that updates the coefficient used by the re-training identification unit based on the difference. The re-training identification unit re-trains the method for identifying the article based on the feature point output from the deep neural network for re-training of the coefficient updated by the coefficient update unit for identification unit.

As shown in FIG. 2, the image conversion unit stops the conversion from the simulation image by the generative adversarial network to the artificial site image within a period in which the re-training is not performed.

As described above, according to the present embodiment, it is possible to implement AI capable of recognizing the site image with a high accuracy and flexibly adapting to an environmental change or a task change without requiring manual annotation for an image for training. The re-training of the feature extraction unit is performed only in the preceding stage (for example, the re-training feature extraction unit 12), and thus power consumption, time, and hardware amount required for the re-training can be reduced.

### Second Embodiment

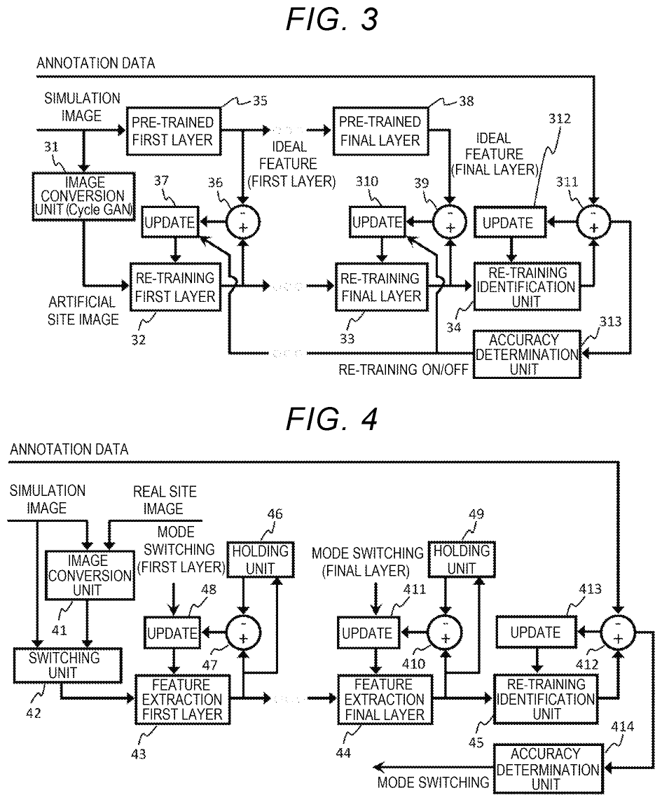

A configuration according to the second embodiment of the invention is shown in FIG. 3. In the present embodiment, training of the re-training feature extraction unit in the first embodiment is performed in order from a preceding layer as much as necessary. Similar to the first embodiment, the image for re-training (simulation image) generated by the simulation and the correct answer information (annotation data) accompanying the image are supplied at the time of the re-training.

At the time of re-training, the simulation images are input to an image conversion unit 31, and the image conversion unit 31 converts each simulation image into an image (artificial site image) imitating a site image. The image conversion unit 31 performs the conversion according to a configuration of a cycle GAN. In order to train the conversion from the simulation image to the image imitating the site image, the image conversion unit 31 is also supplied with an actual site image (real site image for training) (although not shown). The image conversion unit 31 executes the conversion while training the conversion. Accordingly, a site image associated with the annotation data can be obtained as the output of the image conversion unit 31, although the site data is an artificial image (artificial site image).

At the time of re-training, the artificial site image is input to the DNN for article recognition. The DNN for article recognition includes a first layer of re-training feature extraction unit 32 to a final layer of re-training feature extraction unit 33 and a re-training identification unit 34 connected in series. At the time of re-training, the simulation image is also input to the pre-trained feature extraction unit. The pre-trained feature extraction unit connects a first layer of pre-trained feature extraction unit 35 to a final layer of pre-trained feature extraction unit 38 in series.

The DNN is trained in advance using the image generated by simulation and the correct answer information. In the pre-trained DNN model, a portion of the feature extraction unit from a first layer to a final layer is applied from the first layer of pre-trained feature extraction unit 35 to the final layer of pre-trained feature extraction unit 38. The first layer of re-training feature extraction unit 32 to the final layer of re-training feature extraction unit 33 also have the same network structure as the first layer of pre-trained feature extraction unit 35 to the final layer of pre-trained feature extraction unit 38.

Each layer of the pre-trained feature extraction unit outputs a feature point corresponding to one of the supplied simulation images. Using a feature point group (ideal feature) in each layer, the re-training is performed for each layer of the re-training feature extraction unit. At that time, the required number of layers are re-trained in order from the first layer.

At the time of re-training of the first layer of re-training feature extraction unit 32, a difference between a feature point output from the first layer of re-training feature extraction unit 32 and a feature point (ideal feature) output from the first layer of pre-trained feature extraction unit 35 is calculated by an error calculation unit for feature extraction unit 36. Further, a coefficient update unit for feature extraction unit 37 updates a coefficient for the first layer of re-training feature extraction unit 32 based on the difference, and supplies the updated coefficient to the first layer of re-training feature extraction unit 32. The coefficient is a weight coefficient, a bias coefficient, or the like of each neuron in the first layer of re-training feature extraction unit 32. Before the re-training, the coefficient update unit for feature extraction unit 37 sets an initial coefficient to the same coefficient as that of the first layer of pre-trained feature extraction unit 35. As described above, the coefficient of the first layer of re-training feature extraction unit 32 is updated such that the feature point output from the first layer of re-training feature extraction unit 32 is as close as possible to the feature point output from the first layer of pre-trained feature extraction unit 35. Accordingly, a difference between the artificial site image and the simulation image is slightly absorbed in the first layer of re-training feature extraction unit 32. That is, as the output of the first layer of re-training feature extraction unit 32, the feature point that is slightly close to the feature point (ideal feature (first layer)) of the simulation image can be obtained.

During the re-training of the first layer of re-training feature extraction unit 32 (or after the re-training), the re-training of the re-training identification unit 34 is performed. At that time, for each of the second and subsequent layers of the re-training feature extraction unit, the same coefficient as that of the corresponding layer of the pre-trained feature extraction unit is set by the coefficient update unit for feature extraction unit of each layer, and the coefficient is fixed as it is.

The re-training feature extraction unit trains differences such as a light amount, contrast, texture, resolution, and noise of the simulation image from the site image, whereas the re-training identification unit 34 trains a method for identifying a type and a position of the article from the feature point output by the re-training feature extraction unit. Therefore, the difference between the output of the re-training identification unit 34 and the annotation data is calculated by an error calculation unit for identification unit 311. A coefficient update unit for identification unit 312 updates a coefficient for the re-training identification unit 34 based on the difference, and supplies the updated coefficient to the re-training identification unit 34. The coefficient is a weight coefficient, a bias coefficient, or the like of each neuron in the re-training identification unit 34. As described above, the coefficient of the re-training identification unit 34 is updated such that the output of the re-training identification unit 34 is as close as possible to the annotation data.

After the re-training in the re-training identification unit 34 converges, an accuracy determination unit 313 calculates a current recognition accuracy. A difference between the output of the re-training identification unit 34 and the annotation data calculated by the error calculation unit for identification unit 311 is supplied to the accuracy determination unit 313, and thus the current recognition accuracy is calculated based on the difference.

When the calculated current recognition accuracy is equal to or higher than a target value, the re-training of the DNN for article recognition (that is, the re-training feature extraction unit and the re-training identification unit) is completed. On the other hand, when the current recognition accuracy is less than the target value, the process shifts to the re-training of the second layer of the re-training feature extraction unit. This is because the feature point output by the re-training feature extraction unit is determined to be still deviated from the ideal feature (ideal feature (final layer) in FIG. 3) only by the re-training of the first layer.

When the re-training of the second layer of the re-training feature extraction unit is performed, the coefficient of the first layer of re-training feature extraction unit 32 is fixed to the coefficient obtained at the time of re-training. The re-training of the second layer of the re-training feature extraction unit is performed by the same configuration and method as the re-training of the first layer. That is, a difference between a feature point output from the second layer of re-training feature extraction unit and a feature point (ideal feature) output from the second layer of the pre-trained feature extraction unit is calculated by the error calculation unit for feature extraction unit in the second layer. Further, the coefficient update unit for feature extraction unit of the second layer updates a coefficient for the second layer of the re-training feature extraction unit based on the difference, and supplies the updated coefficient to the second layer of the re-training feature extraction unit. The coefficient is a weight coefficient, a bias coefficient, or the like of each neuron in the second layer of re-training feature extraction unit. Before the re-training, the coefficient update unit for feature extraction unit in the second layer sets an initial coefficient to the same coefficient as that of the second layer of pre-trained feature extraction unit. Accordingly, the coefficient of the second layer of re-training feature extraction unit is updated such that the feature point output from the second layer of re-training feature extraction unit is as close as possible to the feature point output from the second layer of pre-trained feature extraction unit. Accordingly, a difference between the artificial site image and the simulation image is further absorbed in the second layer of re-training feature extraction unit. That is, as the output of the second layer of re-training feature extraction unit, the feature point that is further close to the feature point (ideal feature (second layer)) of the simulation image can be obtained.

During the re-training of the second layer of the re-training feature extraction unit (or after the re-training), the re-training of the re-training identification unit 34 is performed again. At that time, coefficients of the re-training feature extraction unit of the third and subsequent layers are continuously fixed. The re-training of the re-training identification unit 34 is performed as described above.

As described above, after the re-training in the re-training identification unit 34 converges, the accuracy determination unit 313 calculates the current recognition accuracy again. When the calculated current recognition accuracy is equal to or higher than the target value, the re-training of the DNN for article recognition is completed. On the other hand, when the current recognition accuracy is less than the target value, the feature point output by the re-training feature extraction unit is determined to be still deviated from the ideal feature (ideal feature (final layer)) only by the re-training of the first layer and second layer. Therefore, in the same manner, the re-training of the third and subsequent layers of the re-training feature extraction unit is continuously performed in order until the recognition accuracy calculated by the accuracy determination unit 313 is equal to or higher than the target value. When the recognition accuracy is equal to or higher than the target value, the re-training of the DNN for article recognition is terminated, and the re-training is completed.

In the above description, the coefficient is updated or fixed in each layer of the re-training feature extraction unit, that is, ON or OFF of the re-training is performed by instructing the coefficient update unit for feature extraction unit of each layer by the accuracy determination unit 313.

Similar to the first embodiment, after the completion of re-training, the inference, that is, the recognition is executed. At this time, the coefficients of the re-training feature extraction unit and the re-training identification unit are fixed to the coefficients obtained at the time of re-training. At the time of inference, an operation of the image conversion unit 31 is unnecessary, and thus the operation is stopped to reduce the power consumption. As shown in FIG. 2, the re-training and the inference may be performed alternately.

In the present embodiment, instead of providing the coefficient update unit for feature extraction unit and the error calculation unit for feature extraction unit for each layer, one or a small number of coefficient update units for feature extraction unit and error calculation units for feature extraction unit may be shared by each layer. This is because update of the coefficients is performed by each layer during different periods.

In the present embodiment, instead of comprehensively performing re-training from the preceding layer including the first layer, the second layer, and the third layer of the feature extraction unit, the re-training may be performed only for effective layers from the preceding layer, such as the first layer, the third layer, and a sixth layer. The effective layer may be selected, for example, based on an experience value of a user, or may be selected according to a past training result. A block such as the first layer of re-training feature extraction unit 32 in FIG. 3 may be a block including not only one layer but also a plurality of layers. For example, the first layer of re-training feature extraction unit and the second layer of re-training feature extraction unit may be one first layer of re-training feature extraction unit. Similar to the first embodiment, a subsequent stage of the re-training feature extraction unit may be a fixed feature extraction unit.

In this manner, in the present embodiment, the trained deep neural network includes a plurality of training layers, the deep neural network for re-training includes a plurality of re-training layers, the pre-trained feature extraction unit performs the training in order from a preceding layer among the plurality of training layers, and the re-training feature extraction unit performs the re-training in order from a preceding layer among the plurality of re-training layers.

The training recognition device further includes the accuracy determination unit 313 that determines an accuracy of the deep neural network for re-training. The re-training feature extraction unit terminates re-training based on an accuracy determination result by the accuracy determination unit.

The training recognition device further includes: the error calculation unit for identification unit 311 that calculates a difference between output data of the re-training identification unit and the annotation data; and the coefficient update unit for identification unit 312 that updates the coefficient used by the re-training identification unit based on the difference. The re-training identification unit re-trains the method for identifying the article based on a feature point output from the deep neural network for re-training of the coefficient updated by the coefficient update unit for identification unit.

As described above, according to the present embodiment, it is possible to implement AI capable of recognizing the site image with a high accuracy and flexibly adapting to an environmental change or a task change without requiring manual annotation for an image for training. The re-training of the feature extraction unit is performed only in a necessary portion, and thus the power consumption, time, and hardware amount required for the re-training can be reduced. Further, the necessary portion is automatically identified by the accuracy determination unit.

### Third Embodiment

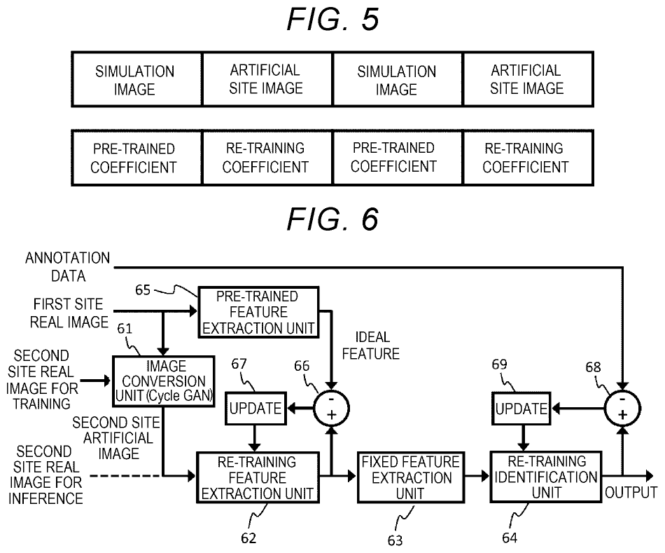

A configuration according to the third embodiment of the invention is shown in FIG. 4, and a time chart thereof is shown in FIG. 5. In the present embodiment, the amount of hardware required for mounting a feature extraction unit is halved by training the feature extraction unit in the second embodiment in a time division operation. Similar to the second embodiment, the image for re-training (simulation image) generated by simulation and the correct answer information (annotation data) accompanying the image are supplied at the time of the re-training. In the following description, an example of a case in which the training of the feature extraction unit in the second embodiment operates in a time division manner is given, and the same can be applied to a case in which the training of the feature extraction unit in the first embodiment is performed in the time division manner.

At the time of the re-training, the simulation images are input to an image conversion unit 41, and the image conversion unit 41 converts each simulation image into an artificial site image imitating a site image. The image conversion unit 41 performs the conversion by a configuration of a cycle GAN. In order to train the conversion from the simulation image to the image imitating the site image, the image conversion unit 41 is also supplied with an actual site image (real site image for training). The image conversion unit 41 executes the conversion while training the conversion. Accordingly, a site image associated with the annotation data can be obtained as the output of the image conversion unit 41, although the site data is an artificial image.

At the time of re-training, the simulation image and the artificial site image are input to the DNN for article recognition. The DNN for article recognition includes a first layer of feature extraction unit 43 to a final layer of feature extraction unit 44 and a re-training identification unit 45 connected in series.

In the present embodiment, a pre-trained feature extraction unit and a re-training feature extraction unit are implemented on one feature extraction unit. This is because the two units have different coefficients but the same network structure. Therefore, at the time of re-training, the pre-trained feature extraction unit and the re-training feature extraction unit are alternately implemented by alternately switching the coefficient set in the feature extraction unit between the coefficient for the pre-trained feature extraction unit (pre-trained coefficient) and the coefficient for the re-training feature extraction unit (re-training coefficient). At that time, a switching unit 42 alternately switches the image input to the first layer of feature extraction unit 43 between the simulation image and the artificial site image.

The DNN is trained in advance using the image generated by the simulation and the correct answer information. In the pre-trained DNN model, a portion of the feature extraction unit from the first layer to the final layer is applied to the first layer of pre-trained feature extraction unit to the final layer of pre-trained feature extraction unit. Therefore, a coefficient update unit for feature extraction unit of each layer stores a coefficient of a corresponding layer obtained by pre-training as a pre-trained coefficient or reads the coefficient from a memory (not shown). The coefficient update unit for feature extraction unit of each layer also stores a coefficient (re-training coefficient) of the corresponding layer of the re-training feature extraction unit, and an initial value before re-training is set to be equal to the pre-trained coefficient.

Similar to the second embodiment, the re-training is performed by a necessary number of layers using the ideal feature of each layer in order from the first layer of the re-training feature extraction unit. As shown in FIG. 5, at the time of re-training of the first layer of the re-training feature extraction unit, the switching unit 42 first inputs the simulation image to the first layer of feature extraction unit 43. At this time, as shown in FIG. 5, a coefficient update unit for feature extraction unit 48 of the first layer sets the pre-trained coefficient for the first layer stored as described above in the first layer of feature extraction unit 43. That is, the first layer of feature extraction unit 43 operates as a first layer of the pre-trained feature extraction unit. That is, a feature point output from the first layer of feature extraction unit 43 corresponds to a feature point (ideal feature (first layer)) output by the first layer of the pre-trained feature extraction unit. Therefore, the feature point is held by a holding unit 46.

Next, as shown in FIG. 5, the artificial site image (that is, the output of the image conversion unit 41) corresponding to the simulation image is input to the first layer of feature extraction unit 43. At this time, as shown in FIG. 5, the coefficient update unit for feature extraction unit 48 of the first layer sets a re-training coefficient for the first layer stored as described above in the first layer of feature extraction unit 43. That is, the first layer of feature extraction unit 43 operates as a first layer of the re-training feature extraction unit. That is, the feature point output from the first layer of feature extraction unit 43 corresponds to a feature point output by the first layer of the re-training feature extraction unit.

Similar to the second embodiment, in order to update the coefficient, a difference between the feature point output by the first layer of feature extraction unit 43 and the feature point held by the holding unit 46 is calculated by an error calculation unit for feature extraction unit 47. Further, the coefficient update unit for feature extraction unit 48 updates and stores the re-training coefficient for the first layer based on the difference.

By alternately repeating the above operations, the re-training coefficient for the first layer is updated such that the feature point output from the first layer of the re-training feature extraction unit is as close as possible to the feature point output from the first layer of pre-trained feature extraction unit. Accordingly, a difference between the artificial site image and the simulation image is slightly absorbed in the first layer of feature extraction unit 43. That is, as the output of the first layer of feature extraction unit 43, the feature point that is slightly close to the feature point (ideal feature (first layer)) of the simulation image can be obtained.

During the re-training of the first layer of the re-training feature extraction unit (or after the re-training), re-training of the re-training identification unit 45 is performed. At that time, in the output of the first layer of feature extraction unit 43, the output as the first layer of the re-training feature extraction unit is transmitted to the second layer of the feature extraction unit. Each layer of the second and subsequent layers of the feature extraction unit is operated as a corresponding layer of the pre-trained feature extraction unit. That is, the coefficient update unit for feature extraction unit of each layer sets the pre-trained coefficient in the feature extraction unit of each layer.

The re-training feature extraction unit trains differences such as a light amount, contrast, texture, resolution, and noise in the simulation image from the site image, whereas the re-training identification unit 45 trains a method for identifying a type and a position of the article from the feature point output by the final layer of feature extraction unit 44. Therefore, the difference between the output of the re-training identification unit 45 and the annotation data is calculated by an error calculation unit for identification unit 412. A coefficient update unit for identification unit 413 updates a coefficient for the re-training identification unit 45 based on the difference, and supplies the updated coefficient to the re-training identification unit 45. The coefficient is a weight coefficient, a bias coefficient, or the like of each neuron in the re-training identification unit 45. Accordingly, the coefficient of the re-training identification unit 45 is updated such that the output of the re-training identification unit 45 is as close as possible to the annotation data.

After the re-training in the re-training identification unit 45 converges, an accuracy determination unit 414 calculates a current recognition accuracy. A difference between the output of the re-training identification unit 45 and the annotation data calculated by the error calculation unit for identification unit 412 is supplied to the accuracy determination unit 414, and thus the current recognition accuracy is calculated based on the difference.

When the calculated current recognition accuracy is equal to or higher than a target value, the re-training is completed. On the other hand, when the current recognition accuracy is less than the target value, the process shifts to the re-training of the second layer of the re-training feature extraction unit. This is because the feature point output by the final layer of feature extraction unit 44 is determined to be still deviated from the ideal feature (ideal feature (final layer) in FIG. 3) only by the re-training of the first layer.

The re-training of the second layer of the re-training feature extraction unit is performed by the same configuration and method as the re-training of the first layer. As shown in FIG. 5, first, the switching unit 42 inputs the simulation image to the first layer of feature extraction unit 43. At this time, as shown in FIG. 5, the coefficient update unit for feature extraction unit 48 of the first layer sets the pre-trained coefficient for the first layer stored as described above in the first layer of feature extraction unit 43. That is, the first layer of feature extraction unit 43 operates as the first layer of the pre-trained feature extraction unit. The coefficient update unit for feature extraction unit of the second layer sets the pre-trained coefficient for the second layer in the second layer of the feature extraction unit. That is, the second layer of the feature extraction unit operates as a second layer of the pre-trained feature extraction unit. Therefore, a feature point output from the second layer of the feature extraction unit corresponds to a feature point (ideal feature (first layer)) output by a second layer of the pre-trained feature extraction unit. Therefore, the feature point is held by a holding unit of the second layer.

Next, as shown in FIG. 5, the artificial site image (that is, the output of the image conversion unit 41) corresponding to the simulation image is input to the first layer of feature extraction unit 43. At this time, as shown in FIG. 5, the coefficient update unit for feature extraction unit 48 of the first layer sets the re-training coefficient for the first layer obtained at the time of re-training in the first layer of feature extraction unit 43. That is, the first layer of feature extraction unit 43 operates as a re-trained first layer of the re-training feature extraction unit. The coefficient update unit for feature extraction unit of the second layer sets the re-training coefficient for the second layer in the second layer of the feature extraction unit. That is, the second layer of feature extraction unit operates as the second layer of the re-training feature extraction unit. Therefore, a feature point output from the second layer of the feature extraction unit corresponds to a feature point output from a second layer of the re-training feature extraction unit.

Similar to the time of re-training of the first layer, a difference between the feature point output by the second layer of the feature extraction unit and the feature point held in the holding unit of the second layer is calculated by the error calculation unit for feature extraction unit of the second layer. Further, the coefficient update unit for feature extraction unit of the second layer updates and stores the re-training coefficient for the second layer based on the difference.

By alternately repeating the above operations, the re-training coefficient for the second layer is updated such that the feature point output from the second layer of the re-training feature extraction unit is as close as possible to the feature point output from the second layer of pre-trained feature extraction unit. Accordingly, the difference between the artificial site image and the simulation image is further absorbed in the second layer of re-training feature extraction unit. That is, as the output of the second layer of re-training feature extraction unit, the feature point that is further close to the feature point (ideal feature (second layer)) of the simulation image can be obtained.

During the re-training of the second layer of the re-training feature extraction unit (or after the re-training), the re-training of the re-training identification unit 45 is performed again. At that time, in the output of the second layer of the feature extraction unit, the output as the second layer of the re-training feature extraction unit is transmitted to the third layer of the feature extraction unit. Each layer of the third and subsequent layers of the feature extraction unit is operated as a corresponding layer of the pre-trained feature extraction unit. That is, the coefficient update unit for feature extraction unit of each layer sets the pre-trained coefficient in the feature extraction unit of each layer. The re-training of the re-training identification unit 45 is performed as described above.

As described above, after the re-training of the re-training identification unit 45 converges, the accuracy determination unit 414 calculates the current recognition accuracy. When the calculated current recognition accuracy is equal to or higher than the target value, the re-training is completed. On the other hand, when the current recognition accuracy is less than the target value, the feature point output by the re-training feature extraction unit is determined to be still deviated from the ideal feature (ideal feature (final layer)) only by the re-training of the first layer and second layer. Therefore, in the same manner, the re-training of the third and subsequent layers of the re-training feature extraction unit is continuously performed in order until the recognition accuracy calculated by the accuracy determination unit 414 becomes equal to or higher than the target value. When the recognition accuracy is equal to or higher than the target value, the re-training is completed.

In the above description, whether to perform an operation mode of the coefficient update unit for feature extraction unit of each layer, that is, an operation for the pre-trained feature extraction unit or the operation for the re-training feature extraction unit, is instructed by a mode switching signal from the accuracy determination unit 414.

Similar to the first embodiment, after the completion of re-training, the inference, that is, the recognition is executed. At this time, the coefficients of the re-training feature extraction unit and the re-training identification unit are fixed to the coefficients obtained at the time of re-training. For a layer for which the re-training of the feature extraction unit is not performed, the pre-trained coefficient is set as it is. At the time of inference, an operation of the image conversion unit 41 is unnecessary, and thus the operation is stopped to reduce the power consumption. As shown in FIG. 2, the re-training and the inference may be performed alternately.

Also in the present embodiment, instead of providing the coefficient update unit for feature extraction unit and the error calculation unit for feature extraction unit for each layer, one or a small number of coefficient update units for feature extraction unit and error calculation units for feature extraction unit may be shared by each layer. This is because update of the coefficients is performed by each layer during different periods.

In the present embodiment, instead of comprehensively performing the re-training from the preceding layer including the first layer, the second layer, and the third layer of the feature extraction unit, the re-training may be performed only for effective layers from the preceding layer, such as the first layer, the third layer, and a sixth layer. A block such as the first layer of feature extraction unit 43 in FIG. 4 may be a block including not only one layer but also a plurality of layers. Similar to the first embodiment, a subsequent stage of the re-training feature extraction unit may be a fixed feature extraction unit.

In this manner, in the present embodiment, the trained deep neural network and the deep neural network for re-training are constituted as a shared deep neural network, and includes the switching unit 42 that switches the shared deep neural network by the time division operation.

The training recognition device further includes: the error calculation unit for identification unit 412 that calculates a difference between output data of the re-training identification unit and the annotation data; and the coefficient update unit for identification unit 413 that updates the coefficient used by the re-training identification unit based on the difference. The re-training identification unit re-trains the method for identifying the article based on a feature point output from the deep neural network for re-training of the coefficient updated by the coefficient update unit for identification unit.

As described above, according to the present embodiment, it is possible to implement AI capable of recognizing the site image with a high accuracy and flexibly adapting to an environmental change or a task change without requiring manual annotation for an image for training. The re-training of the feature extraction unit is performed only in a necessary portion, and thus the power consumption, time, and hardware amount required for the re-training can be reduced. Further, the necessary portion is automatically identified by the accuracy determination unit. By performing the training of the feature extraction unit by the time division operation, the time required for the training is twice as long as that of the second embodiment, and the amount of hardware required for the implementation of the feature extraction unit is reduced by half as compared with that in the second embodiment.

### Fourth Embodiment

A configuration according to the fourth embodiment of the invention is shown in FIG. 6. In the present embodiment, instead of generating the original image and the annotation data by simulation as in the first embodiment, the original image and the annotation data are used as an actual image (first site real image) of a first site, which is an existing site, and annotation data corresponding thereto. Based on this, the DNN for article recognition for a second site is re-trained.

An image conversion unit 61 converts a first site real image to a second site artificial image by the configuration and operation of the cycle GAN. In order to train the conversion, the image conversion unit 61 is also supplied with a second site actual image (a second site real image for training), which is another site.

An image trained in advance using the first site actual image and the annotation data corresponding thereto is applied to a pre-trained feature extraction unit 65. A feature point output from the pre-trained feature extraction unit 65 corresponds to an ideal feature.

In this manner, in the present embodiment, the training recognition device includes: the image conversion unit 61 that inputs a first site image (a first site real image), which is an existing actual site image, and a second site image (a second site real image for training), which is a another actual site image, to a generative adversarial network and converts the first site image into an artificial site image (second site artificial image); the pre-trained feature extraction unit 65 that inputs the first site image to a trained deep neural network (for example, a pre-trained DNN model) trained using the first site image and annotation data for the first site image and outputs a feature point of the first site image at time of re-training; a re-training feature extraction unit 62 that inputs the artificial site image to a deep neural network for re-training (for example, a DNN model having the same network structure as the pre-trained feature extraction unit 15), re-trains a difference between the artificial site image and the first site image, and outputs a feature point of the artificial site image; an error calculation unit for feature extraction unit 66 that calculates a difference between a feature point output by the re-training feature extraction unit and a feature point output by the pre-trained feature extraction unit; a coefficient update unit for feature extraction unit 67 that updates a coefficient of the re-training feature extraction unit used for re-training based on the difference; and a re-training identification unit 64 that re-trains the method for identifying the article based on a feature point output from the deep neural network for re-training of the coefficient updated by the coefficient update unit for feature extraction unit.

The present embodiment has the same configuration as that of the first embodiment and performs the same operation as that of the first embodiment, and thus a detailed description thereof will be omitted. According to the present embodiment, by utilizing the image for the existing site and the annotation data, it is possible to implement AI that can recognize a new site image with a high accuracy and can flexibly adapt to an environmental change or a task change without requiring manual annotation for the new site image. The re-training of the feature extraction unit is performed only in a preceding stage, and thus the power consumption, time, and hardware amount required for the re-training can be reduced.

### Fifth Embodiment

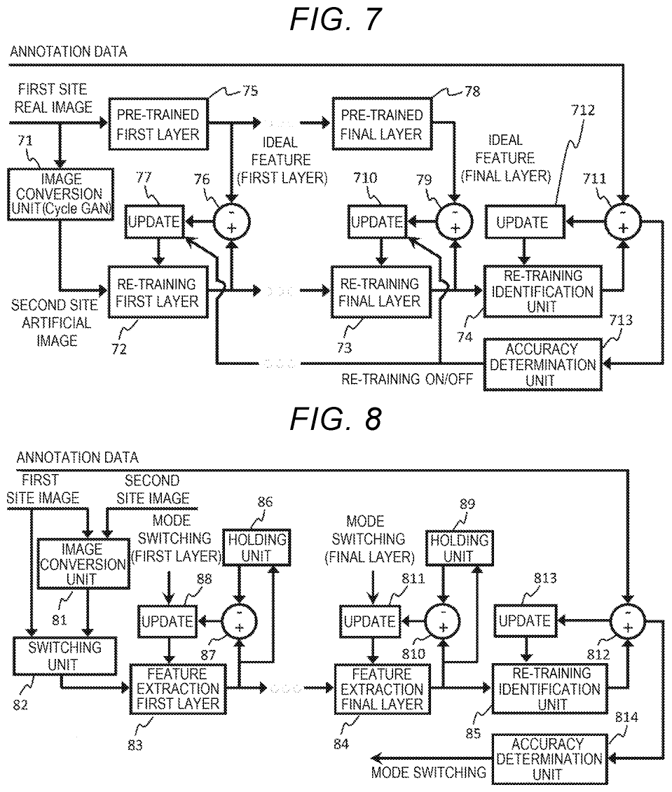

A configuration according to the fifth embodiment of the invention is shown in FIG. 7. In the present embodiment, instead of generating the original image and the annotation data by simulation as in the second embodiment, the original image and the annotation data are used as an actual image (first site real image) of a first site, which is an existing site, and annotation data corresponding thereto. Based on this, the DNN for article recognition for a second site is re-trained. An image conversion unit 71 converts a first site real image to a second site artificial image by the configuration and operation of the cycle GAN. In order to train the conversion, the image conversion unit 71 is also supplied with a second site actual image (a second site real image for training) (not shown).

An image trained in advance using the first site actual image and the annotation data corresponding thereto is applied from a first layer of pre-trained feature extraction unit 75 to a final layer of pre-trained feature extraction unit 78. A feature point output from the first layer of pre-trained feature extraction unit 75 to the final layer of pre-trained feature extraction unit 78 is an ideal feature (first layer) to an ideal feature (final layer).

In this manner, in the present embodiment, the trained deep neural network includes a plurality of training layers, the deep neural network for re-training includes a plurality of re-training layers, the pre-trained feature extraction unit performs training in order from a preceding layer among the plurality of training layers, and the re-training feature extraction unit performs re-training in order from a preceding layer among the plurality of re-training layers.

The training recognition device further includes an accuracy determination unit 713 that determines an accuracy of the deep neural network for re-training. The re-training feature extraction unit terminates re-training based on an accuracy determination result by the accuracy determination unit.

The present embodiment has the same configuration as that of the second embodiment and performs the same operation as that of the second embodiment, and thus a detailed description thereof will be omitted. According to the present embodiment, by utilizing the image for the existing site and the annotation data, it is possible to implement AI that can recognize a new site image with a high accuracy and can flexibly adapt to an environmental change or a task change without requiring manual annotation for the new site image. The re-training of the feature extraction unit is performed only in a necessary portion, and thus the power consumption, time, and hardware amount required for the re-training can be reduced. Further, the necessary portion is automatically identified by the accuracy determination unit.

### Sixth Embodiment

A configuration according to the sixth embodiment of the invention is shown in FIG. 8. In the present embodiment, instead of generating the original image and the annotation data by simulation as in the third embodiment, the original image and the annotation data are used as an actual image (first site image) of a first site, which is an existing site, and annotation data corresponding thereto. Based on this, the DNN for article recognition for a second site is re-trained.

An image conversion unit 81 converts a first site image to a second site artificial image by the configuration and operation of the cycle GAN. In order to train the conversion, the image conversion unit 81 is also supplied with a second site actual image (a second site image).

An image trained in advance using the first site actual image and the annotation data corresponding thereto is applied to the pre-trained feature extraction unit.

In this manner, in the present embodiment, the trained deep neural network and the deep neural network for re-training are constituted as a shared deep neural network, and include a switching unit 82 that switches the shared deep neural network by the time division operation.

The present embodiment has the same configuration as that of the third embodiment and performs the same operation as that of the third embodiment, and thus a detailed description thereof will be omitted. According to the present embodiment, by utilizing the image for the existing site and the annotation data, it is possible to implement AI that can recognize a new site image with a high accuracy and can flexibly adapt to an environmental change or a task change without requiring manual annotation for the new site image. The re-training of the feature extraction unit is performed only in a necessary portion, and thus the power consumption, time, and hardware amount required for the re-training can be reduced. Further, the necessary portion is automatically identified by the accuracy determination unit. By performing the training of the feature extraction unit by the time division operation, the amount of hardware required for the implementation of the feature extraction unit is reduced by half as compared with the fifth embodiment. On the other hand, time required for the training is doubled as compared with the fifth embodiment.

### Seventh Embodiment

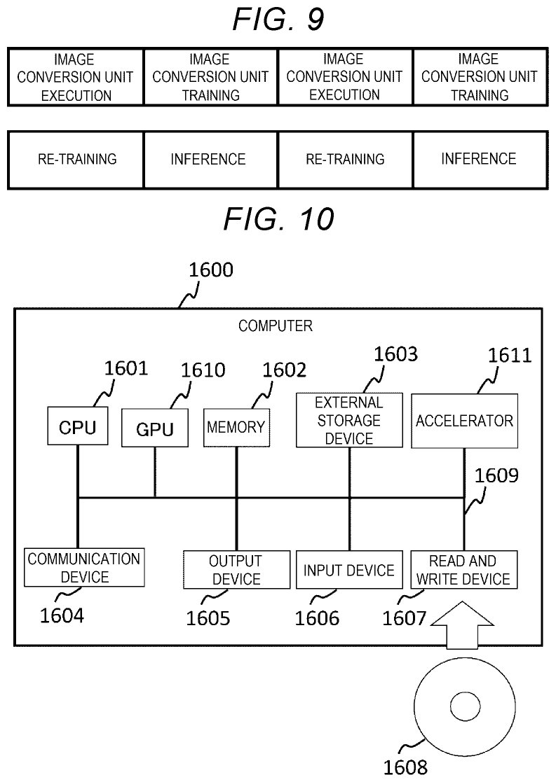

A configuration according to the seventh embodiment of the invention is shown in FIG. 9. The present embodiment shows an example different from that in FIG. 2 regarding operation timing of the image conversion unit.

In the present embodiment, the training and execution of the image conversion unit are not performed at the same time as shown in FIG. 2, but are divided into a training period and an execution period as shown in FIG. 9. The training of the image conversion unit is performed in all or a part of the period during which the DNN for article recognition performs inference.

During the re-training period of the DNN for article recognition, the image conversion unit only executes the conversion and does not perform the training. Therefore, by stopping the training function of the cycle GAN, the power consumption of the image conversion unit can be reduced. When the image conversion unit is neither training nor executing conversion, the operation of the image conversion unit may be stopped in order to reduce the power consumption.

According to the present embodiment, the overall power consumption during the re-training period of the DNN for article recognition can be reduced.

What is claimed is:

1. A training recognition device comprising:
an image conversion unit configured to input a simulation image and an actual site image into a generative adversarial network and convert the simulation image into an artificial site image;
a pre-trained feature extraction unit configured to input the simulation image to a trained deep neural network trained using the simulation image and annotation data for the simulation image and output a feature point of the simulation image at time of re-training;
a re-training feature extraction unit configured to input the artificial site image to a deep neural network for re-training, re-train a difference between the simulation image and the artificial site image, and output a feature point of the artificial site image;
an error calculation unit for feature extraction unit configured to calculate a difference between the feature point output by the re-training feature extraction unit and the feature point output by the pre-trained feature extraction unit;
a coefficient update unit for feature extraction unit configured to update a coefficient of the re-training feature extraction unit used for re-training based on the difference; and
a re-training identification unit configured to re-train a method for identifying an article based on a feature point output from the deep neural network for re-training of the coefficient updated by the coefficient update unit for feature extraction unit.

2. The training recognition device according to claim 1, wherein
the trained deep neural network includes a plurality of training layers,
the deep neural network for re-training includes a plurality of re-training layers,
the pre-trained feature extraction unit performs the training in order from a preceding layer among the plurality of training layers, and
the re-training feature extraction unit performs the re-training in order from a preceding layer among the plurality of re-training layers.

3. The training recognition device according to claim 2, further comprising:
an accuracy determination unit configured to determine an accuracy of the deep neural network for re-training, wherein
the re-training feature extraction unit terminates re-training based on an accuracy determination result by the accuracy determination unit.

4. The training recognition device according to claim 2, wherein
the trained deep neural network and the deep neural network for re-training are constituted by a shared deep neural network, and
the training recognition device further includes a switching unit configured to switch the shared deep neural network by a time division operation.

5. The training recognition device according to claim 1, further comprising:
an error calculation unit for identification unit configured to calculate a difference between output data of the re-training identification unit and the annotation data; and
a coefficient update unit for identification unit configured to update the coefficient used by the re-training identification unit based on the difference, wherein
the re-training identification unit re-trains the method for identifying the article based on the feature point output from the deep neural network for re-training of the coefficient updated by the coefficient update unit for identification unit.

6. The training recognition device according to claim 2, further comprising:
an error calculation unit for identification unit configured to calculate a difference between output data of the re-training identification unit and the annotation data; and
a coefficient update unit for identification unit configured to update the coefficient used by the re-training identification unit based on the difference, wherein
the re-training identification unit re-trains the method for identifying the article based on the feature point output from the deep neural network for re-training of the coefficient updated by the coefficient update unit for identification unit.

7. The training recognition device according to claim 4, further comprising:
an error calculation unit for identification unit configured to calculate a difference between output data of the re-training identification unit and the annotation data; and
a coefficient update unit for identification unit configured to update the coefficient used by the re-training identification unit based on the difference, and wherein
the re-training identification unit re-trains the method for identifying the article based on the feature point output from the deep neural network for re-training of the coefficient updated by the coefficient update unit for identification unit.

8. The training recognition device according to claim 1, wherein
the image conversion unit stops the conversion from the simulation image by the generative adversarial network to the artificial site image within a period in which the re-training is not performed.

9. A training recognition device comprising:
an image conversion unit configured to input a first site image, which is an existing actual site image, and a second site image, which is another actual site image, to a generative adversarial network, and convert the first site image into an artificial site image;
a pre-trained feature extraction unit configured to input the first site image to a trained deep neural network trained using the first site image and annotation data for the first site image and output a feature point of the first site image at time of re-training;
a re-training feature extraction unit configured to input the artificial site image to a deep neural network for re-training, re-train a difference between the first site image and the artificial site image, and output a feature point of the artificial site image;
an error calculation unit for feature extraction unit configured to calculate a difference between the feature point output by the re-training feature extraction unit and the feature point output by the pre-trained feature extraction unit;
a coefficient update unit for feature extraction unit configured to update a coefficient of the re-training feature extraction unit used for re-training based on the difference; and
a re-training identification unit configured to re-train a method for identifying an article based on a feature point output from the deep neural network for re-training of the coefficient updated by the coefficient update unit for feature extraction unit.

10. The training recognition device according to claim 9, wherein
the trained deep neural network includes a plurality of training layers,
the deep neural network for re-training includes a plurality of re-training layers,
the pre-trained feature extraction unit performs the training in order from a preceding layer among the plurality of training layers, and
the re-training feature extraction unit performs the re-training in order from a preceding layer among the plurality of re-training layers.

11. The training recognition device according to claim 10, further comprising:
an accuracy determination unit configured to determine an accuracy of the deep neural network for re-training, wherein
the re-training feature extraction unit terminates re-training based on an accuracy determination result by the accuracy determination unit.

12. The training recognition device according to claim 10, wherein
the trained deep neural network and the deep neural network for re-training are constituted by a shared deep neural network, and
the training recognition device further includes a switching unit configured to switch the shared deep neural network by a time division operation.
